(19) United States
(12) Patent Application Publication
(10) Pub. No.: US 2015/0325148 A1
(43) Pub. Date: Nov. 12, 2015

(54) CARDIO PULMONARY RESUSCITATION (CPR) TRAINING SIMULATION SYSTEM AND METHOD FOR OPERATING SAME

(71) Applicant: I.M.LAB INC., Daejeon (KR)

(72) Inventors: Won Joon Kim, Daejeon (KR); Ye Ram Kwon, Daejeon (KR); Sung Won Lee, Daejeon (KR); Ji Hoon Jeong, Daejeon (KR); Noh Young Park, Daejeon (KR); Woon Tack Woo, Daejeon (KR)

(21) Appl. No.: 14/650,568

(22) PCT Filed: Jun. 11, 2014
(86) PCT No.: PCT/KR2014/005122

§ 371 Date: Jun. 8, 2015

(30) Foreign Application Priority Data
Jul. 16, 2013 (KR) 10-2013-0083419
Dec. 9, 2013 (KR) 10-2013-0152174
Feb. 3, 2014 (KR) 10-2014-0012109

(51) Int. Cl. G09B 23/28; G06T 19/00; G09B 5/02

(52) U.S. Cl. CPC G09B 23/288; G09B 5/02; G06T 19/006; G06T 2210/41

(57) ABSTRACT

A CPR training simulation system is provided. The system obtains signals from various sensor installed in a dummy. Specifically, the system obtains signals representing pressure applied to the dummy, bending degree of an air pocket, and expansion of airway in the dummy. Using the obtained data, the system calculates a flow rate representing air flow via the airway of the dummy and compares with a reference flow rate. The system may include an portable terminal for displaying various guide for a trainee during CPR training.

### TECHNICAL FIELD

The present invention relates to a cardio pulmonary resuscitation (CPR) training simulation system, and more particularly, to a CPR training simulation system to provide real-time feedback on first aid performed by a trainee through a sensor kit, thereby enhancing an educational effectiveness and a method of the same, and an augmented reality (AR)-based interactive CPR training simulator.

### BACKGROUND ART

Cardio pulmonary resuscitation (CPR) may be a form of first aid performed when breathing is suspended due to a heart and lung shutdown. When circulation is blocked due to a heart attack, an oxygen deficiency may occur within one second and a glucose and an adenosine triphosphate (ATP) deficiency may occur after a period of about five minutes elapses. In this example, when circulation does not resume within about four to ten minutes, irreversible damage may be caused to nerve tissues including the central nervous system may, which may lead to a biological death. Thus, to resuscitate a patient, resumption of circulation and breathing within a shortest time may be needed to provide an air supply.

An appropriate treatment of a first responder may be the most significant factor for resuscitating a patient experiencing a cardiac arrest. Thus, resuscitation of the patient may depend on an amount of time during which the first responder appropriately performs CPR. To enhance an effect and significance of CPR performed by the first discoverer, CPR training is being widely implemented and supported at a national level.

In general, since CPR training is typically provided on a theoretical basis, verifying a reaction of a patient and an accuracy of a treatment, and providing a one-to-one feedback from a trainer are difficult. Also, in an actual emergency situation, most of users may incorrectly perform CPR due to a degree of ineptitude despite having undergone CPR training.

Performing CPR at an accurate compression position, at an accurate compression intensity, during an accurate period of time may be necessary. However, when a typical human body model, for example, a dummy is used in CPR training, the aforementioned conditions may not be met by the user.

In terms of the typical dummy, since a sensor and a program for sensing CPR execution are provided in a single body, maintenance of a sensing device may not be easy. When the human body model is changed, an overall program may need to be reprogrammed and thus, maintenance of the program may also difficult.

### DISCLOSURE OF INVENTION

### Technical Goals

An aspect of the present invention provides an augmented reality (AR)-based interactive cardio pulmonary resuscitation (CPR) simulation apparatus and system to provide feedback on an accurate compression position, intensity, and period to a user based on an augmented reality in real time, intuitively display a correct posture by acquiring a depth image of a posture of the user, and provide an augmented reality of an actual emergency situation such that the user performs CPR in the actual emergency situation without trepidation.

Another aspect of the present invention also provides a CPR training simulation system to provide real-time feedback on a reaction of a trainee through an interconnection between a smart device and a human body model including various sensors, thereby enhancing an educational effectiveness.

Still another aspect of the present invention also provides a CPR training simulation system for enhancing a usage efficiency of a human body model and an effectiveness of a CPR training, the system including a sensor kit provided to be easily attached to and detached from a general human body model which is widely used for practice and not providing a feedback, and configured to perform a communication function and a function to sense chest compression intensity and depth, an execution of an artificial respiration, and a free airway, wherein the sensor kit operates in conjunction with a portable terminal including a CPR training program so as to be universally mounted on the general human body model and enable the general human body model to provide the feedback.

Yet another aspect of the present invention also provides a CPR training simulation system to allow a CPR training program to be easily updated in a sensor kit and a portable terminal, thereby allowing a CPR training program to be easily changed and maintained without need to change a human body model.

Further another aspect of the present invention also provides a CPR training simulation system to store CPR training information in a server through a communication network such that CPR training result information is verified through a communication network, for example, the Internet, in real time.

Technical goals to be achieved by example embodiments of the disclosure are not limited to the foregoing and thus, other technical goals may also be present.

### Technical Solutions

According to an aspect of the present invention, there is provided an augmented reality (AR)-based interactive cardio pulmonary resuscitation (CPR) simulator including a compression information receiver to receive, from at least one pressure sensor, a compression intensity and a compression period input to the at least one pressure sensor, an airway information receiver to receive, from an On/Off switch circuit, information indicating whether an airway of a dummy is expanded, a flow rate information calculator to receive bending degree data received from a bending sensor and calculate flow rate data for an amount of air flow in the airway, and, an AR outputter to output a result by comparing at least one item of received information to at least one item of reference information through a first projector.

According to another aspect of the present invention, there is also provided a CPR training simulation system including a human body model including body parts for a CPR training, a sensor kit universally attachable to and detachable from the human body model, and to sense and collect information on first aid administered by a user to the human body model for the CPR training, and a portable terminal to display guide information based on an emergency situation on a screen, and to perform a real-time analysis and display by receiving information on the first aid sensed and collected by the sensor kit in a process of the CPR training based on the guide information.

The human body model may include a chest compression sensor to measure at least one of a compression intensity, a number of compressions, a compression time from a chest of the human body model, an artificial respiration sensor mounted on the human body model to measure a breathing amount, a breathing intensity, a number of breaths, and a breathing duration while an artificial respiration is performed, a free airway sensor to sense whether a free airway is established for the human body model, and a compression position sensor to detect a pressed position on the chest of the human body model.

The sensor kit may include a pressure depth sensor to sense a depth of a pressure applied to the chest, a communicator to communicate with the portable terminal, and a controller to control the communicator to transmit at least one item of first aid information measured by the chest compression sensor, the artificial respiration sensor, and the free airway sensor attached to the human body model, so as to be wired or wirelessly connected to the chest compression sensor, the artificial respiration sensor, and the free airway sensor.

The sensor kit may further include a wired or wireless communication module to change an operation program of the controller.

The portable terminal may include an information receiver to receive first aid information transmitted from the sensor kit, a processor to output CPR procedure guide information through a reproduction and output an analysis result by analyzing the first aid information, and a display to display the received first aid information and display the CPR procedure guidance information under a control of the processor.

The CPR training simulation system may further include a server to receive information on a procedure of the CPR training from the portable terminal and store the received information such that a person connected through a communication network verifies the information in real time.

According to still another aspect of the present invention, there is also provided an operation method of a CPR training simulation operated by a portable terminal, the method including executing a CPR training program and setting a wireless communication with a sensor kit, selecting an emergency situation from virtual emergency situation scenarios based on a user input, explaining a scenario by outputting an image and sound effect and an explanation about the selected emergency situation, performing a consciousness check by outputting a voice guidance for the consciousness check of a patient facing the emergency situation, performing a chest compression by receiving, from the sensor kit, information on a first aid executed by a user in response to an instruction of the chest compression for the patient and displaying a progress and a result of the chest compression on a screen, performing an artificial respiration by receiving, from the sensor kit, information on first aid executed by a user in response to instructions of the artificial respiration for the patient and displaying a progress and a result of the artificial respiration on the screen, performing a post-processing by outputting voice information and an image related to a CPR post-processing procedure after a termination of the artificial respiration, and analyzing and evaluating the first aid performed by the user and displaying a result on a terminal screen.

The operation method may further include transmitting, by the portable terminal, information on a procedure of the CPR training to be stored in a server using a communication network such that a person connected through the communication network verifies a result and the procedure of the CPR training in real time.

### Advantageous Effects

According to an aspect of the present invention, it is possible to provide real-time feedback on an accurate compression position, intensity, and period to a user based on an augmented reality, intuitively display a correct posture by acquiring a depth image of a posture of the user, and provide an augmented reality of an actual emergency situation such that the user performs CPR in the actual emergency situation without embarrassment.

According to another aspect of the present invention, it is possible to enhance an educational effectiveness by providing feedback on a reaction of a trainee in real time through an interoperation between a smart device and a human body model including various sensors.

According to still another aspect of the present invention, it is possible to enhance an effectiveness of a CPR training through a universal application to various types of general human body models which are widely used for practice and not providing feedback, thereby improving a CPR education performance of a human body model for use in the CPR training at a minimized cost.

According to yet another aspect of the present invention, it is possible to display a CPR procedure guidance and feedback on a user reaction through a glasses-type display or a mobile device such that the user performs a CPR sequentially based on the CPR procedure guidance.

### BRIEF DESCRIPTION OF DRAWINGS

FIG. 1 is a configuration diagram illustrating an augmented reality (AR)-based interactive cardio pulmonary resuscitation (CPR) simulation system according to an example embodiment of the present invention.

FIG. 2 is a diagram illustrating an AR-based interactive CPR simulator of FIG. 1.

FIG. 3 is a diagram illustrating an example of a dummy on which the pressure sensor, the On/Off switch circuit, and the bending sensor of FIG. 1 are mounted.

FIG. 4 is a diagram illustrating an example of at least one red, green, and blue (RGB)-depth sensor of FIG. 1 mounted on a user and an RGB-depth image acquired by capturing the same.

FIG. 5 is a diagram illustrating an example embodiment of an AR visualization result obtained through a projection performed by a first projector of FIG. 1.

FIG. 6 is a diagram illustrating an example in which a user performs artificial respiration on a dummy of FIG. 1.

FIG. 7 is a diagram illustrating an example in which a user performs CPR on the dummy of FIG. 1.

FIG. 8 is a diagram illustrating another example of a dummy on which the pressure sensor, the On/Off switch circuit, and the bending sensor of FIG. 1 are mounted.

FIG. 9 is a configuration diagram illustrating an example of a CPR training simulation system according to an example embodiment of the present invention.

FIG. 10 is a configuration diagram illustrating another example of a CPR training simulation system according to an example embodiment of the present invention.

FIG. 11 is a block diagram illustrating a sensor kit of FIG. 9.

FIG. 12 is a signal flow diagram illustrating a sensor kit mounted on a human body model.

FIG. 13 is a block diagram illustrating a portable terminal of FIG. 9.

FIG. 14 is a flowchart illustrating a procedure of performing a CPR simulation operating method according to an example embodiment of the present invention.

FIG. 15 is a diagram illustrating a virtual emergency situation scenario according to an example embodiment of the present invention.

FIG. 16 is a diagram illustrating an emergency situation scenario selected in an example of FIG. 15.

FIG. 17 is a diagram illustrating a procedure of a consciousness check for a patient.

FIG. 18 is a diagram illustrating a terminal screen displaying a procedure of making an emergency request or an aid request.

FIG. 19 is a diagram illustrating a terminal screen displaying a chest compression operation.

FIG. 20 is a diagram illustrating a terminal screen displaying an artificial respiration operation.

FIG. 21 is a diagram illustrating a terminal screen displaying a procedure of post-processing after a recovery.

FIG. 22 is a diagram illustrating a terminal screen displaying an operation of evaluating first aid performed.

FIG. 23 is a configuration diagram illustrating still another example of a CPR training simulation system according to an example embodiment of the present invention.

FIG. 24 is a diagram illustrating a screen displaying a CPR training feedback according to an example embodiment of the present invention.

FIG. 25 is a diagram illustrating a CPR execution procedure based on the CPR training simulation system of FIG. 23.

### BEST MODE FOR CARRYING OUT THE INVENTION

Reference will now be made in detail to embodiments of the present invention, examples of which are illustrated in the accompanying drawings. The features described herein may be embodied in different forms, and are not to be construed as being limited to the examples described herein. Like reference numerals in the drawings denote like elements, and redundant descriptions of like elements will be omitted herein.

It will also be understood that when an element or layer is referred to as being “on” or “connected to” or “operatively connected” to another element or layer, it can be directly on or connected to the other element or layer or through intervening elements or layers may be present. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Hereinafter, example embodiments are described below in order to explain the present invention by referring to the figures.

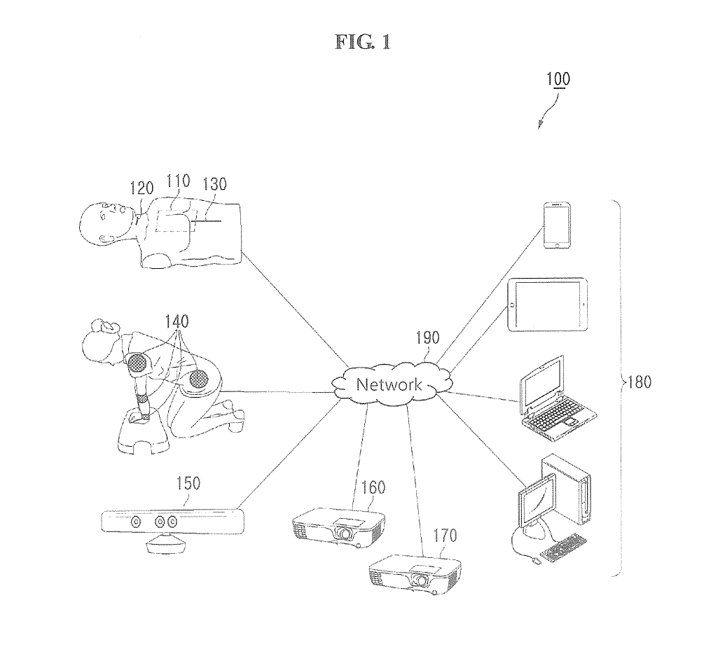

FIG. 1 is a configuration diagram illustrating an augmented reality (AR)-based interactive cardio pulmonary resuscitation (CPR) simulation system according to an example embodiment of the present invention. Referring to FIG. 1, an AR-based interactive CPR simulation system 100 may include at least one pressure sensor 110, an On/Off switch 120, a bending sensor 130, at least one red, green, and blue (RGB)-depth sensor 140, an RGB-depth camera, 150, a first projector 160, a second projector 170, and an AR-based interactive CPR simulator 180. The descriptions will be provided based on the AR-based interactive CPR simulation system 100 of FIG. 1 as an example and thus, the disclosure is not limited thereto.

In this example, each element of FIG. 1 may, in general, be connected through a network 190. For example, as illustrated in FIG. 1, the at least one pressure sensor 110, the On/Off switch 120, and the bending sensor 130 may be connected to the AR-based interactive CPR simulator 180 through the network 190. Additionally, the at least one RGB-depth sensor 140 and the RGB-depth camera 150 may be connected to the AR-based interactive CPR simulator 180 through the network 190. Also, the first projector 160 and the second projector 170 may be connected to the AR-based interactive CPR simulator 180 through the network 190.

Here, the network 190 may indicate a connection structure through which a mutual exchange of information is to be performed among nodes such as terminals and servers. The network 190 may include, for example, a Bluetooth module, an Internet connection a local area network (LAN), a wireless local area network (WLAN), a wide area network (WAN), a personal area network (PAN), a third generation (3G), a fourth generation (4G), a long term evolution (LTE), and a wireless fidelity (Wi-Fi). However, the network 190 is not limited to the types suggested in the foregoing. Although FIG. 1 illustrates the at least one pressure sensor 110, the On/Off switch 120, the bending sensor 130, the at least one RGB-depth sensor 140, the RGB-depth camera 150, the first projector 160, the second projector 170, and the AR-based interactive CPR simulator 180 as an example, the disclosure is not limited thereto.

The at least one pressure sensor 110 may be disposed on a chest part of a dummy. The at least one pressure sensor 110 may sense a compression intensity and a compression period input to the at least one pressure sensor 110. To be used as the at least one pressure sensor 110, for example, at least two pressure sensors may be provided along an X coordinate axis and at least two pressure sensors may be provided along a Y coordinate axis. Also, the at least one pressure sensor 110 may be disposed on a posterior side of a chest of the dummy, and at least one spring may be disposed between the at least one pressure sensor 110 and an anterior side of the chest of the dummy. The at least one spring may provide an elasticity to a user by moving in a vertical direction when the user performs CPR using the dummy. Through this, the user may recognize the dummy as a real person. Also, the at least one pressure sensor 110 may be disposed at a position corresponding to a position of the at least one spring such that a pressure applied through the at least one spring is received to the at least one pressure sensor 110.

An On/Off switch circuit 120 may verify whether an airway of the dummy is opened or closed. As an example, the On/Off switch circuit 120 may be disposed in a uvula part of the dummy. In this example, when a neck of the dummy is arched backward, the airway may be opened and thus, the On/Off switch circuit 120 may be switched off. When the neck of the dummy is arched forward, the airway may be closed and thus, the On/Off switch circuit 120 may be switched on. As such, the On/Off switch circuit 120 may sense that the airway of the dummy is opened or closed.

The bending sensor 130 may be disposed on a lung part or an abdomen part of the dummy. The bending sensor 130 may output a bending degree as a form of data. When the user performs an artificial respiration through a mouth of the dummy, an air pocket disposed in a lower portion of the bending sensor 130 may be inflated. When an air flow into the air pocket is continuous, the air pocket may be further inflated such that the bending sensor 130 is gradually tilted to be at a predetermined level. Through this, it is determined whether the user provides a sufficient supply of air using the bending sensor 130.

The at least one RGB-depth sensor 140 may be attached to, for example, a wrist, an elbow, and a waist of the user, and captured by the RGB-depth camera 150. When the at least one RGB-depth sensor 140 is captured by the RGB-depth camera 150, a three-dimensional (3D) image may be generated. Also, angles of the wrist, the elbow, the waist, a shoulder, and the like may be obtained by capturing the at least one RGB-depth sensor 140. Through this, an input value may be provided to the user in real time in a case in which, for example, a posture of the user is in inappropriate posture. The at least one RGB-depth sensor 140 may also have different colors.

The first projector 160 may output an AR display to provide real-time feedback to the user based on at least one item of information data received from the at least one pressure sensor 110, the On/Off switch circuit 120, the bending sensor 130, and the at least one RGB-depth sensor 140. In this example, the first projector 160 may project the AR display output from the AR-based interactive CPR simulator 180, and the AR screen may correspond to an area in which the dummy is located.

The second projector 170 may project an AR display output from the AR-based interactive CPR simulator 180 to represent an emergency situation in an augmented reality, and the AR display may correspond to an area perpendicular to the area in which the dummy is located.

In this example, the AR display may be at least one image representing the emergency situation. Thus, through the AR display, the user may appropriately perform CPR and the artificial respiration in an actual situation.

The AR-based interactive CPR simulator 180 may be a device to collect images and data received from the at least one pressure sensor 110, the On/Off switch circuit 120, the bending sensor 130, the at least one RGB-depth sensor 140, and the RGB-depth camera 150 and analyze the collected images and data, thereby providing real-time feedback on the artificial respiration and the CPR to the user. Here, the AR-based interactive CPR simulator 180 may output data to provide the feedback using the first projector 160, and output data to provide an AR image using the second projector 170.

In this example, the AR-based interactive CPR simulator 180 may be configured as a computer to access a server or a terminal of a remote area through the network 190.

Here, the computer may include, for example, a laptop computer and a desktop computer including a Web browser. Also, the AR-based interactive CPR simulator 180 may be configured as a terminal to access a server or a terminal of a remote area through the network 190. The user terminal 100 may be, for example, a wireless communication device ensuring a portability and a mobility and include any type of handheld-based wireless communication device such as a personal communication system (PCS), a global system for mobile communications (GSM), a personal digital cellular (PDC), a personal handyphone system (PHS), a personal digital assistant (PDA), an international mobile telecommunication (IMT)-2000, a code division multiple access (CDMA)-2000, a W-code division multiple access (W-CDMA), a wireless broadband (WiBro) Internet terminal, a smartphone, a smart pad, a tablet personal computer (PC), and the like.

Hereinafter, the following descriptions will be provided based on the aforementioned AR-based interactive CPR simulation system as an example.

As of late, the number of cardiac arrest patients may exceed one million people per annum. When a first responder performs the CPR on a cardiac arrest patient, a survival rate of the cardiac arrest patient may be about 1% which is remarkably low when compared to foreign regions. In this case, about 1% of first responders may be capable of performing CPR.

In general, since CPR training is typically provided on a theoretical basis, it is verifying a reaction of a patient and accuracy on a treatment, and providing one-to-one feedback from a trainer are difficult. Additionally, the CPR may need to be performed at an accurate compression position, at an accurate compression intensity, during an accurate period of time. When a typical dummy is used in the CPR training, the aforementioned conditions may not be met by the user. Thus, in an actual emergency situation, most users may incorrectly perform CPR due to an ineptitude despite having received the CPR training.

Accordingly, the AR-based interactive CPR simulation system according to an example embodiment of the present invention may provide real-time feedback on an accurate compression point, intensity, and period to a user through an augmented reality, and intuitively display a correct posture by acquiring a depth image including a posture of the user. Also, the AR-based interactive CPR simulation system may realize an augmented reality representing an actual emergency situation, thereby enabling the user to perform CPR in the actual emergency situation without trepidation.

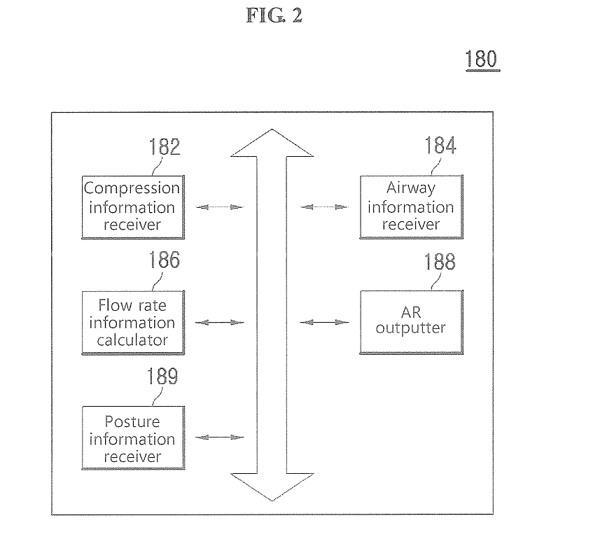

FIG. 2 is a diagram illustrating the AR-based interactive CPR simulator of FIG. 1. Referring to FIG. 2, the AR-based interactive CPR simulator 180 may include a compression information receiver 182, an airway information receiver 184, a flow rate information calculator 186, an AR outputter 188, and a posture information receiver 189.

In this example, a connection of the network 190 may indicate that the at least one pressure sensor 110, the On/Off switch 120, the bending sensor 130, the at least one RGB-depth sensor 140, the RGB-depth camera 150, the first projector 160, the second projector 170, and the AR-based interactive CPR simulator 180 generate a communication object at a communication contact point to communicate with a terminal connected to the network 190. The AR-based interactive CPR simulator 180 may perform a data exchange through the communication object.

Hereinafter, the AR-based interactive CPR simulator according to an example embodiment of the present invention will be explained with reference to the following descriptions.

Referring to FIG. 2, from the at least one pressure sensor 110, the compression information receiver 182 may receive a compression intensity and a compression period input to the at least one pressure sensor 110. The compression intensity may be, for example, an intensity of a pressure applied by a user to the at least one pressure sensor 110 through a spring, and the compression period may be obtained based on a speed of the pressure applied by the user to the at least one pressure sensor 110 through the spring. The at least one pressure sensor 110 may be mounted on at least one position in a chest part of a dummy, and the at least one pressure sensor 110 mounted on the at least one position may contain location data for identifying the at least one position. As an example, the at least one pressure sensor 110 may contain identifiers, for example, 1, 2, 3, and 4 in an order of up, down, left, and right. Also, the at least one pressure sensor 110 may be mounted on the at least one position on the chest part of the dummy, and at least one spring (not shown) may be mounted on a surface of an upper portion of the at least one pressure sensor 110.

Also, the AR outputter 188 may output a result to the at least one pressure sensor 110 by comparing the compression intensity to reference compression intensity information, calculate a pressure rate based on the compression period input to the at least one pressure sensor 110, output a result by comparing the pressure rate to reference pressure rate information, and output a reference compression position based on the compression intensity input to the at least one pressure sensor 110. In this example, the compression information receiver 182 or the AR outputter 188 may include an analog-to-digital converter (ADC) to convert analog data into digital data.

The airway information receiver 184 may receive whether an airway of the dummy is expanded from the On/Off switch circuit 120. In this example, when the airway of the dummy is expanded, for example, when a hole of the airway is opened, the On/Off switch circuit 120 may be switched off. Conversely, when the hole of the airway is closed, the On/Off switch circuit 120 may be switched on. Thus, the AR outputter 188 may output data indicating that the airway is opened when the airway of the dummy is expanded and the On/Off switch circuit 120 is in an off state. Also, AR outputter 188 may output data indicating that the airway of the dummy is closed when the airway is obstructed and the On/Off switch circuit 120 is in an on state.

The flow rate information calculator 186 may receive bending degree data received from the bending sensor 130, and calculate flow rate data for an amount of air flow in the airway of the dummy. For example, the calculated flow rate data may be obtained based on a tilt of the bending sensor 130 corresponding to the bending degree data of the bending sensor 130, and the AR outputter 188 may output a result by comparing the calculated flow rate data to reference flow rate data used in a process of artificial respiration.

The posture information receiver 189 may receive an image captured by at least one RGB-depth camera 140 from the RGB-depth camera 150. In this example, the AR outputter 188 may output a result by comparing a position and angle of the at least one RGB-depth sensor 140 to a reference position and a reference angle. Also, the at least one RGB-depth sensor 140 may be attached to at least one position in the user, and the at least one position may be, for example, a waist, a shoulder, an elbow, and a wrist.

The AR outputter 188 may output a result by comparing at least one item of information received through the first projector 160 to at least one item of reference information. Here, the AR outputter 188 may allow the second projector 170 to project an AR-based emergency situation image for representing an emergency situation. In this example, an area toward which the second projector 170 directs a projection may be perpendicular to an area toward which the first projector 160 directs a projection.

Since the descriptions provided with reference to the AR-based interactive CPR simulation system of FIG. 1 are also applicable here, repeated descriptions with respect to the AR-based interactive CPR simulator of FIG. 2 will be omitted for increased clarity and conciseness.

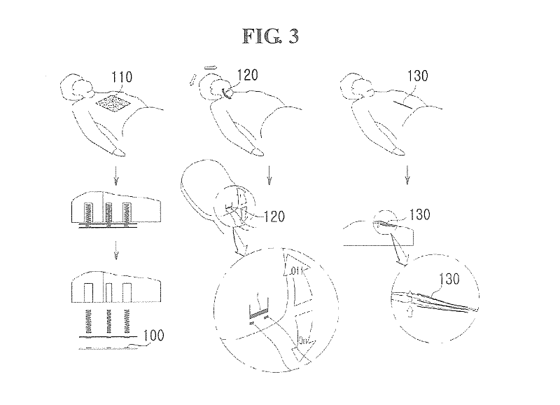

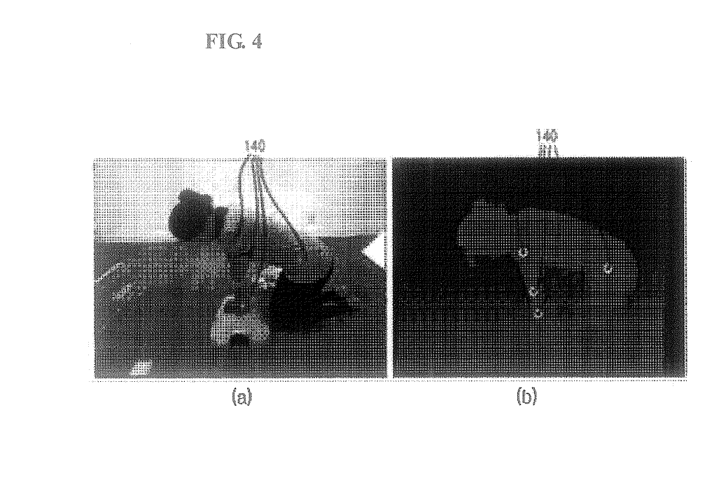

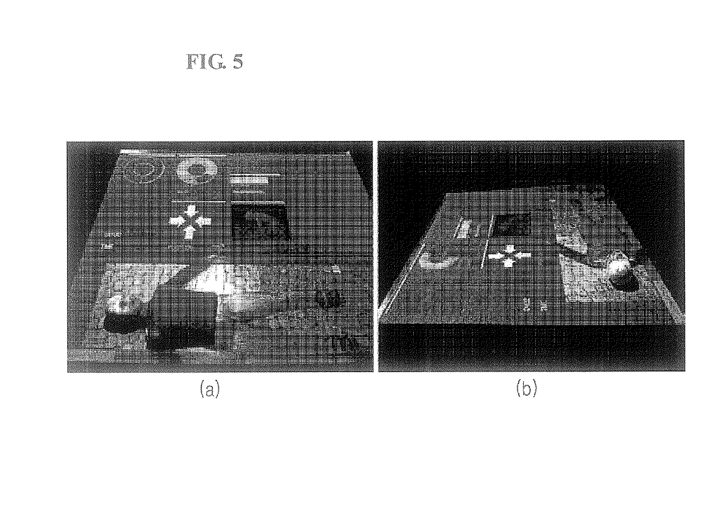

FIG. 3 is a diagram illustrating an example of a dummy on which the pressure sensor, the On/Off switch circuit, and the bending sensor of FIG. 1 are mounted. FIG. 4 is a diagram illustrating an example of the at least one RGB-depth sensor of FIG. 1 mounted on a user and an RGB-depth image acquired by capturing the same. FIG. 5 is a diagram illustrating an example of an AR visualization result obtained through a projection performed by the first projector of FIG. 1.

Referring to a left portion of FIG. 3, the at least one pressure sensor 110 may be mounted on the dummy. When the user compresses a chest part of the dummy, a compression intensity and a compression period may be delivered such that the at least one pressure sensor 110 senses the delivered compression intensity and compression period.

Referring to a middle portion of FIG. 3, the On/Off switch circuit 120 may be mounted on the dummy. When the user arches a neck of the dummy backward or forward, the airway may be free or obstructed. Thus, the On/Off switch circuit 120 may output an off signal when the airway is free, and may output an on signal when the airway is obstructed.

Referring to a right portion of FIG. 3, the bending sensor 130 may be mounted on the dummy. When the user performs an artificial respiration through a mouth, an air pocket in a lower portion in which the bending sensor 130 is located may expand. Through this, the bending sensor 130 may be arched and a degree to which the bending sensor 130 is arched may be output. Thus, the degree may be used as an input value for verifying an amount of air flow.

Referring to a part (a) of FIG. 4, the at least one RGB-depth sensor 140 may be attached to the user. Referring to a part (b) of FIG. 4, an RGB-depth image may be acquired by capturing the at least one RGB-depth sensor 140 using the RGB-depth camera 150. The RGB-depth image may express a depth, which may lead to, for example, a 3D effect. Thus, whether a posture of the user is correct may be verified three-dimensionally as well as two dimensionally. Also, an angle of the at least one RGB-depth sensor 140 may be measured to be used as an input value for verifying whether the posture of the user is correct.

Referring to parts (a) and (b) of FIG. 5, a realistic situation in which the dummy is laid down on a street may be displayed based on an augmented reality. In this example, the first projector 160 may output a real time result by comparing a compression intensity of a CPR to a reference compression intensity and comparing a pressure rate of CPR performed to a reference pressure rate, thereby providing real-time feedback to the user such that the user corrects a posture for performing CPR. The first projector 160 may display whether a compression position, a compression direction, and a compression posture are correct, and also display duration from a time at which the user starts a compression.

Since the descriptions provided with reference to the AR-based interactive CPR simulation system of FIGS. 1 and 2 are also applicable here, repeated descriptions with respect to the AR-based interactive CPR simulator of FIGS. 3 through 5 will be omitted for increased clarity and conciseness.

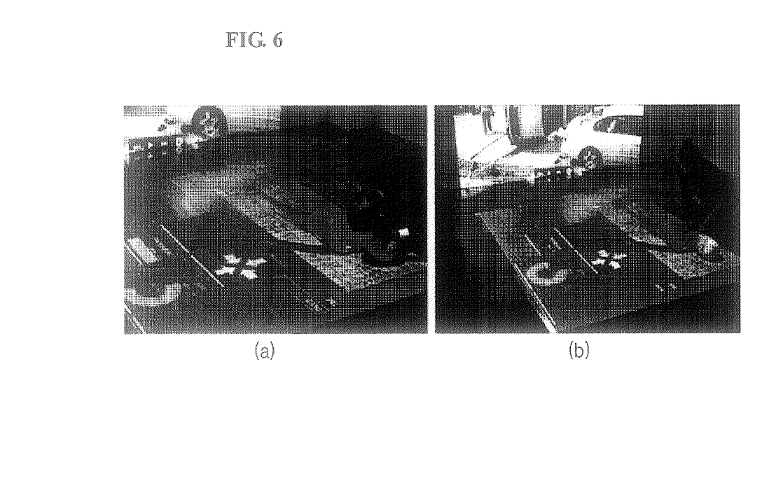

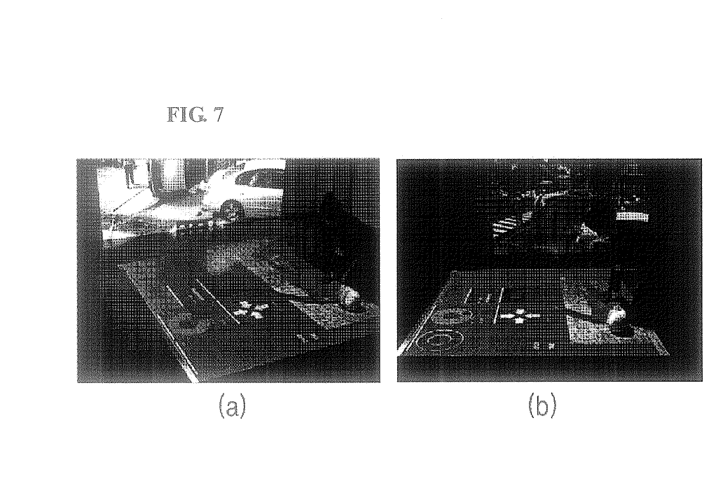

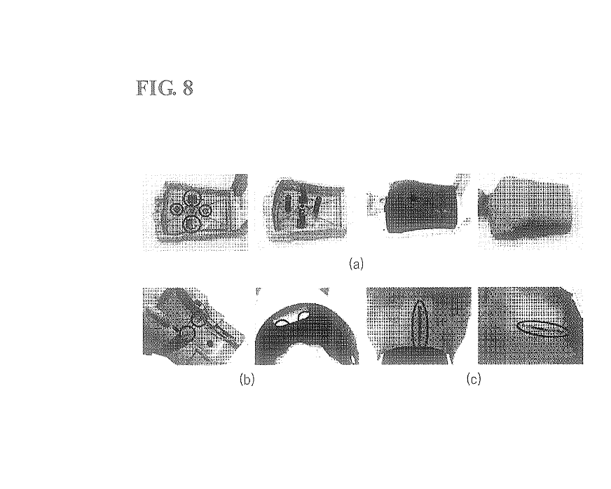

FIG. 6 is a diagram illustrating an example in which a user performs artificial respiration on the dummy of FIG. 1. FIG. 7 is a diagram illustrating an example in which a user performs a CPR on the dummy of FIG. 1. FIG. 8 is a diagram illustrating another example of the dummy on which the pressure sensor, the On/Off switch circuit, and the bending sensor of FIG. 1 are mounted.

Referring to parts (a) and (b) of FIG. 6, the second projector 170 may be used to project a realistic emergency situation. In this example, the second projector 170 may output a sound such as noise as well as an image. Also, the first projector 160 may output whether the user a sufficient amount of air at an accurate point in time, in comparison to a reference amount of air.

Referring to parts (a) and (b) of FIG. 7, when the user performs the CPR, for example, when the user performs a chest compression, the first projector 160 may provide feedback through a comparison to various items of reference information to a user.

A spring attached to an upper side of a position on which the at least one pressure sensor 110 is mounted, and a procedure of assembling the dummy may be may be illustrated with reference to a part (a) of FIG. 8.

In this example, the at least one pressure sensor 110 may be disposed in a cross form in which right angles are formed in vertical and horizontal directions. A position on which the On/Off switch circuit 120 is mounted may be illustrated with reference to a part (b) of FIG. 8. A position on which the bending sensor 130 is mounted may be illustrated with reference to a part (c) of FIG. 8. In this example, the at least one pressure sensor 110, the On/Off switch circuit 120, and the bending sensor 130 may be mounted on the dummy as an embedded hardware.

Since the descriptions provided with reference to the AR-based interactive CPR simulation system of FIGS. 1 through 5 are also applicable here, repeated descriptions with respect to the AR-based interactive CPR simulator of FIGS. 6 through 8 will be omitted for increased clarity and conciseness.

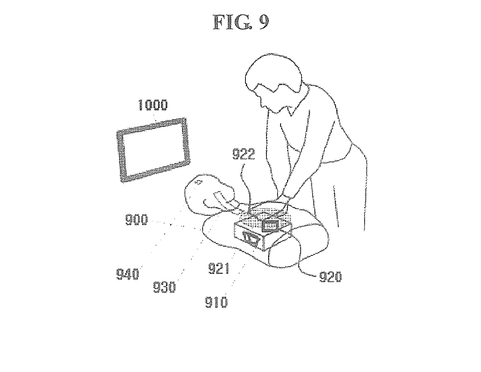

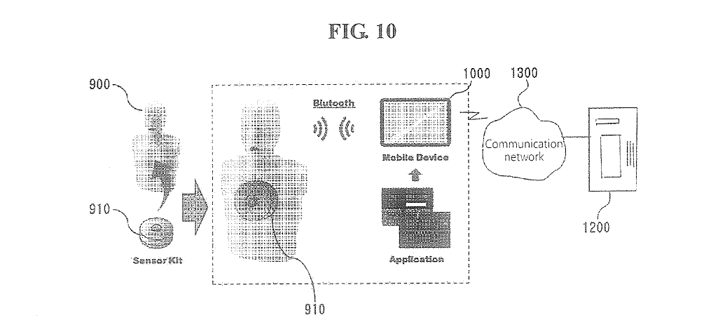

FIG. 9 is a configuration diagram illustrating an example of a CPR training simulation system according to an example embodiment of the present invention. FIG. 10 is a configuration diagram illustrating another example of a CPR training simulation system according to an example embodiment of the present invention.

Referring to FIGS. 9 and 10, the CPR simulation system may include a human body model 900, a sensor kit 910, a portable terminal 1000, and a server 1200 connected to a communication network 1300.

The human body model 900 may include body parts used in a process of CPR training. The human body model 900 may be, for example, a mannequin for use in the CPR training and provided in a form similar to a real human body. The human body model 900 may include sensors, for example, a chest compression sensor 920 including a pressure sensor, the artificial respiration sensor 930 including a pneumatic sensor or a flowmeter, an free airway sensor 940 including an free airway sensor switched on and off in response to opening and closing of an airway, and a compression position sensor 922 including, for example, a compression position sensing pad to detect a chest compression position of a trainee. Also, the human body model 900 may include the sensor kit 910 attachable to and detachable from the human body model 900.

The aforementioned human body model 900 may sense a first aid administered by a user in a process of performing the CPR.

The chest compression sensor 920 may be disposed on a center of a chest of the human body model 900. The chest compression sensor 920 may measure a compression intensity, a number of compressions, and a compression time through a pressure sensor disposed on the center of the chest when a pressure is applied to the human body model 900 in a process of performing the CPR. Here, the number of compressions and the compression time may be used to calculate a pressure rate.

The artificial respiration sensor 930 may be disposed in a head part or a neck part of the human body model 900. The artificial respiration sensor 930 may measure a breathing intensity, a number of breaths, and a breathing duration of the human body model 900 when the artificial respiration is performed through an oral cavity or a nasal cavity of the human body model 900.

The free airway sensor 940 may be configured as an On/Off switch disposed in the head part of neck part of the human body model 900 to be switched on and off, thereby sensing whether an airway of the human body model 900 is free. The free airway sensor 940 may be disposed in the head part of the human body model 900 to output whether the airway is free by outputting a different signal. For example, the free airway sensor 940 may output an off signal “0” when the airway of the human body model 900 is free, and output an on signal “1” or a signal opposite from the off signal when the airway is obstructed. Thus, the sensor kit 910 may verify whether the airway of the human body model 900 is free or obstructed based on a signal output from the free airway sensor 940.

The compression position sensor 922 may include, for example, a switch pad with 9 directions or sensing sensors provided in a plurality of arrays. The compression position sensor 922 may be attached to the chest part of the human body model 900 to transmit the chest compression position to the sensor kit 910 by detecting the chest compression position when the user performs the chest compression.

The server 1200 may be configured as, for example, a server system such as a Web server including a server communicator, an Internet service unit, a CPR service unit, a controller, and a storage to connect to a communication network, and then receiving the CPR training procedure of users or CPR trainees and an analysis result transmitted from the portable terminal 1000 and storing a result of the receiving such that a supervisor or a user connects to the Internet and verifies the CPR training procedure of users or CPR trainees and the analysis result in real time.

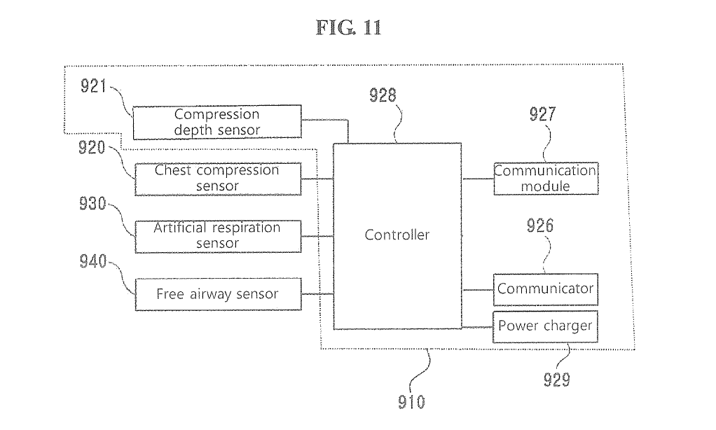

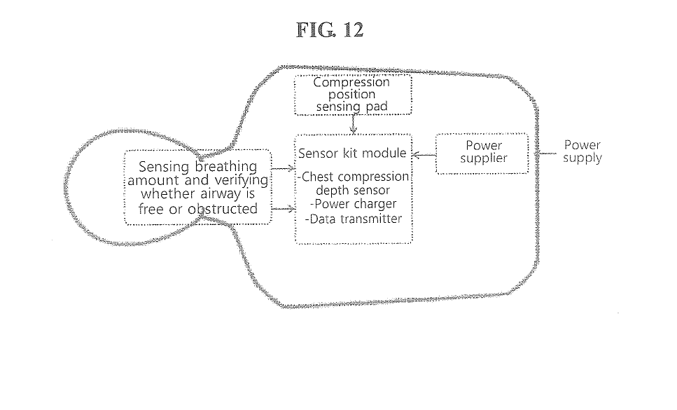

FIG. 11 is a block diagram illustrating the sensor kit 910 of FIG. 9. FIG. 12 is a signal flow diagram illustrating the sensor kit 910 mounted on a human body model.

As illustrated in FIG. 11, the sensor kit 910 may include a compression depth sensor 921 mounted on the human body model 900 to sense a chest compression depth in a process of performing the chest compression, a communicator 926 to wirelessly communicate with the portable terminal 1000, a communication module 927, for example, a Bluetooth module and a universal serial bus (USB) used to change a CPR education program, the chest compression sensor 920 attached to the human body model, the artificial respiration sensor 930, and a controller 928 controlling the communicator 926 and the communication module 927 to transmit first aid information measured by the free airway sensor 940. When the sensor kit 910 is mounted on the human body model 900, the sensor kit 910 may be wired or wirelessly connected to the chest compression sensor 920, the artificial respiration sensor 930, and the free airway sensor 940 to receive signals sensed by the chest compression sensor 920, the artificial respiration sensor 930, and the free airway sensor 940, thereby transmitting the received signals to the portable terminal 1000. For example, the sensor kit may be configured to be attachable to or detachable from the human body model, and provided separately from the chest compression sensor 920, the artificial respiration sensor 930, and the free airway sensor 940 attached to the human body model. Thus, the sensor kit may be provide in a form of a single kit set that is attachable to or detachable from the human body model to be used for the CPR training. The sensor kit 910 may be universally inserted and installed in a typical human body model that does not provide a feedback so as to measure the chest pressure depth. Also, as illustrated in FIG. 12, the sensor kit 910 may sense, for example, a chest compression intensity, a chest compression position, a chest pressure rate, a volume of the artificial respiration, whether the airway is free or obstructed, and whether an automatic defibrillation pad is attached to a correct position, from the chest compression sensor 920, the artificial respiration sensor 930, and the free airway sensor 940.

The communicator 926 may communicate with the portable terminal 1000 of an external user. The communicator 926 may be realized to be, for example, the Bluetooth module, a short-range wireless communication module, and a wireless Internet module.

The controller 928 may collect first aid information associated with a first aid of the user and sensed by the chest compression sensor 920, the artificial respiration sensor 930, and the free airway sensor 940, and transmit the collected first aid information through the communicator 926 to the portable terminal 1000 disposed in an external area.

The user terminal 1000 may include a program for CPR education to receive the first aid information transmitted from the sensor kit 910 and provide the received first aid information to the user as real-time feedback. When the user completes the first aid, the portable terminal 1000 may analyze a user reaction based on the received first aid information, and output a result of the analyzing. In the CPR program, a change such as an upgrade may be performed through a wired communication using, for example, a USB, or through a wireless communication using, for example, a Bluetooth module.

For example, the program for CPR education of the portable terminal 1000 may be implemented to be easily updated in response to a change in CPR instructions without a need to change the human body model or the sensor kit.

The program for CPR education may provide various virtual scenarios, for example, a cardiac arrest during an exercise, the cardiac arrest due to an accident, and the cardiac arrest due to a sea casualty, based on a situation in which the CPR is to be performed. The program may be implemented with an enhanced reality by displaying a virtual patient on a display and changing, for example, a complexion and a face expression of the virtual patient based on user reaction information.

The program may output a voice instruction to guide an operation of performing the CPR. Also, the program may provide a real-time audiovisual feedback based on the first aid information received from the sensor kit 910. An analysis and evaluation result for each trainee transmitted from the sensor kit 910 may be displayed on a portable terminal and an electronic device of the trainee.

The program for CPR education of the portable terminal 1000 may be implemented to store execution data on trainees and include a viewer and a server allowing a trainer to read the execution data as necessary, thereby easily reading and analyzing a CPR training result.

The user terminal 1000 may transmit first aid result information and the user reaction information analyzed based on the received first aid information to the server 1200 through the communication network 1300 using a wired or wireless Internet connection.

The program for CPR education of the portable terminal 1000 may be provided based on a user interface such as a game, thereby enhancing an effectiveness of the education.

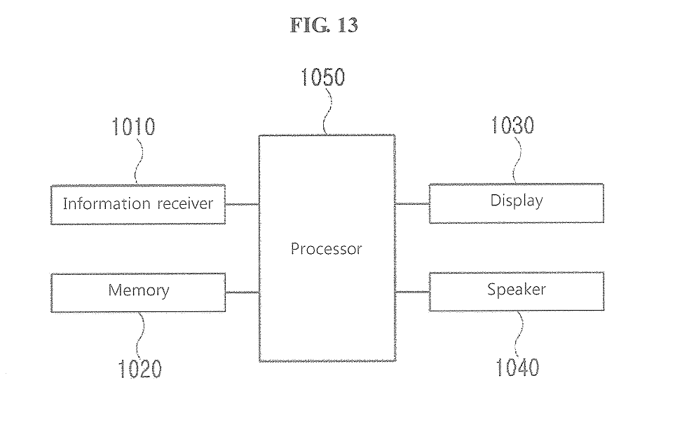

FIG. 13 is a block diagram illustrating the portable terminal 1000 of FIG. 9.

The portable terminal 1000 may be provided in a form of any type of portable wireless communication terminal device, for example, a smartphone, a tablet computer, a laptop computer, a digital broadcast terminal device, a PDA, and a PMP.

As illustrated in FIG. 13, the portable terminal 1000 may include an information receiver 1010, a memory 1020, a display 1030, a speaker 1040, and a processor 1050.

The information receiver 1010 may receive information on first aid performed by a user, the information which is transmitted through the communicator 926 of the sensor kit 910. Hereinafter, the information on first aid performed by the user may also be referred to as, for example, user first aid information. The memory 1020 may store a CPR training program and the user first aid information received from the information receiver 1010.

The processor 1050 may execute the CPR training program and provide guidance on each operation of a CPR procedure, thereby acquiring information on a first aid performed based on the provided guidance. For example, the processor 1050 may receive user first aid information for each operation of the CPR procedure through the information receiver 1010. The processor 1050 may output the first aid information received from the information receiver 1010 using the display 1030 and/or the speaker 1040 in real time. In this example, the processor 1050 may calculate a pressure rate based on the number of compressions and a compression time applied to the chest part of the human body model 900. Also, when CPR is terminated, the processor 1050 may analyze a user reaction based on the user first aid information stored in the memory 1020 and output a result of the analyzing.

The display 1030 may display a first aid analysis result, the first aid information, and CPR procedure guide information output from the processor 1050. The display 1030 may be configured as a display device, for example, a touch screen, an LCD display, an LED display, and a head mounted display (HMD). When the display is configured as the HMD, the display may receive data in real time and display the received data on a screen through a reproduction, thereby ensuring an interface use in a real situation. The display 1030 may be configured to use, for example, a mobile phone, a tablet PC, a smart TV, and a monitor operating in conjunction with a computer, as an output device.

The speaker 1040 may externally output an audio signal into which the CPR procedure information, the first aid information, and the first aid analysis information are converted by the processor 1050.

In this example, the sensor kit 910 may detect the user first aid information and transmit the user first aid information to the portable terminal 1000 such that the user verifies feedback on the user reaction for the CPR through the portable terminal 1000. Also, the portable terminal 1000 may connect to a communication network to transmit, to the server 1200, information on an overall procedure of first aid performed by the user in a process of the CPR training and an analysis result thereof. However, the disclosure is not limited thereto. Alternatively, the sensor kit 910 may directly transmit the measured first aid information to a supervisor terminal (not shown) or the server 1200, or transmit the measured first aid information through the portable terminal 1000 to the supervisor terminal (not shown) or the server 1200. Through this, a supervisor may monitor and manage individual CPR training data for each user through the server 1200 or the supervisor terminal in real time.

A subject for the aforementioned CPR training system may be, for example, the general public, a related-field expert, and a trainer for providing the CPR education.

In general, when the CPR training starts, a virtual situation similar to an actual emergency situation and a tutorial for the CPR execution may be provided through the portable terminal or an electronic device corresponding to the portable terminal. The trainee may use the human body model including the sensor kit to receive an audiovisual feedback through a display of an electronic device, for example, the portable terminal, a mobile computing device such as a tablet PC, a smartphone, and a laptop, and an HMD, operating in conjunction with the sensor kit. Through this, the trainee may correct a reaction of the user in real time during the CPR training.

The sensor kit may sense a chest compression depth, a chest compression intensity, a chest pressure rate, an intensity of an artificial respiration, a volume of the artificial respiration, whether the airway is free, and whether an AED pad is attached at a correct position during the CPR performed by the trainee. When an overall process of the CPR is completed, an execution result of the trainee may be provided on a screen of an electronic device. Also, the execution result may be transmitted from the electronic device to a server so as to be read by the trainer.

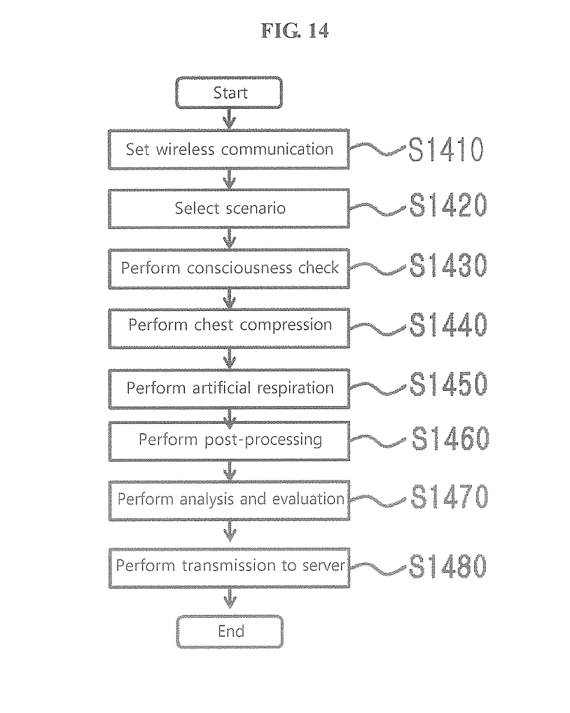

FIG. 14 is a flowchart illustrating a procedure of performing a CPR simulation operating method according to an example embodiment of the present invention.

As illustrated in FIG. 14, the CPR training simulation operation method using the CPR training simulation system having a configuration described with reference to FIGS. 9 through 13 may include operation S1410 of setting a wireless communication, operation S1420 of selecting a scenario, operation S1430 of performing a consciousness check.

The CPR training simulation operation method may also include operation S1440 of performing a chest compression, operation S1450 of performing an artificial respiration, operation S1460 of performing post-processing, operation S1470 of performing analysis and evaluation, and operation S1480 of performing transmission to a server.

Hereinafter, a procedure of processing the CPR training simulation operation method of FIG. 14 will be explained with reference to the following descriptions.

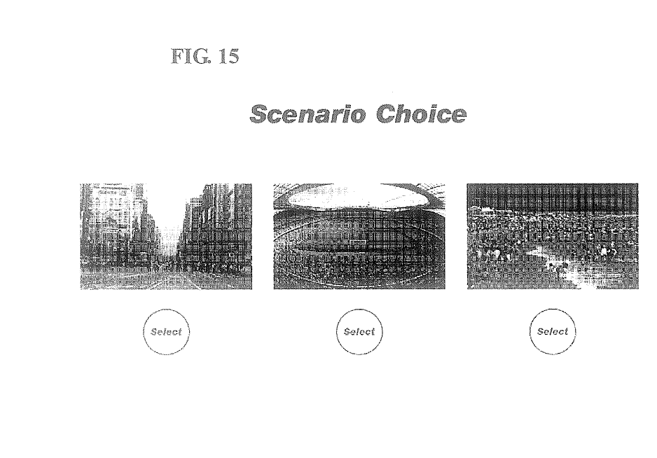

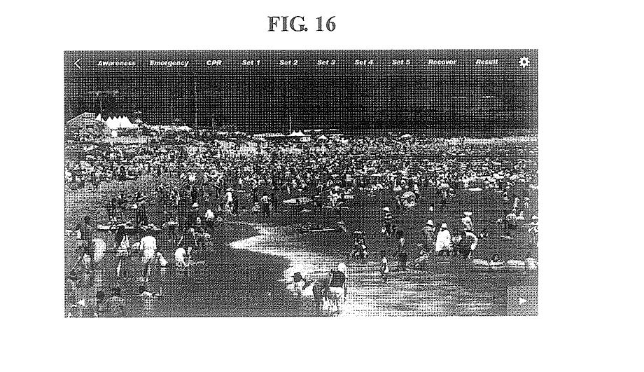

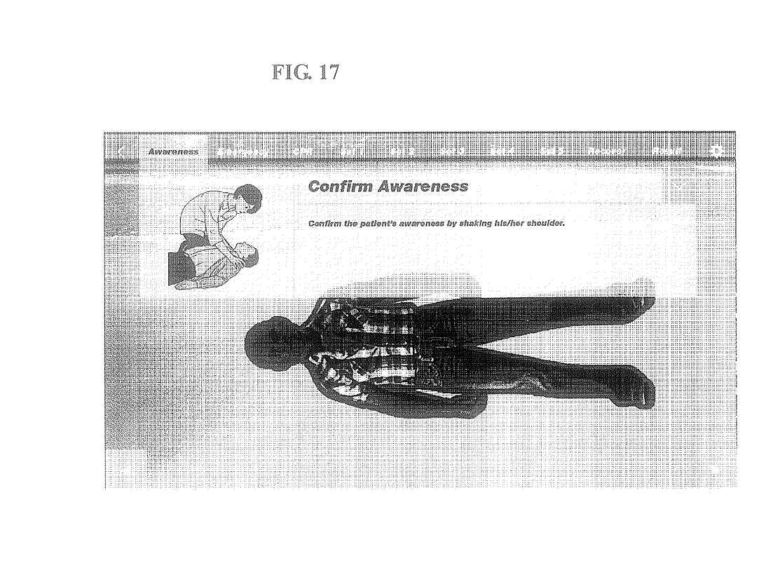

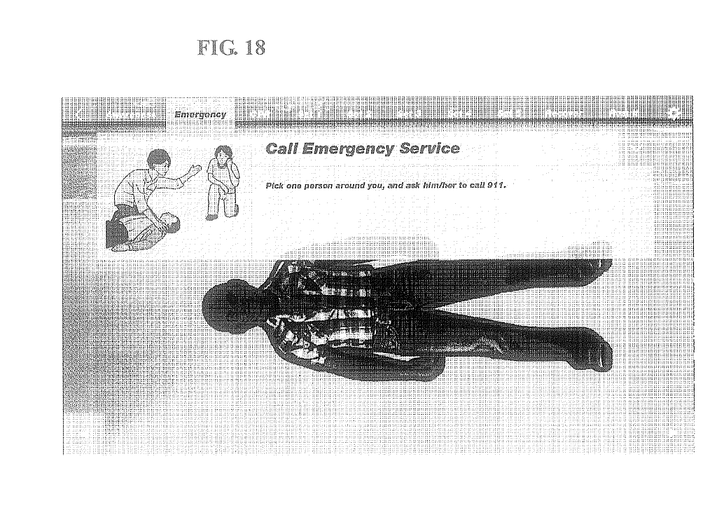

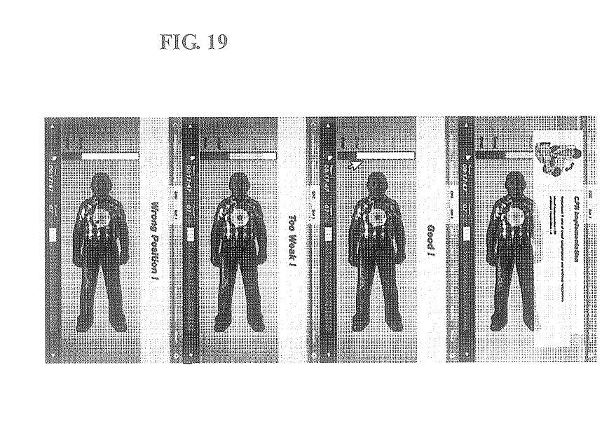

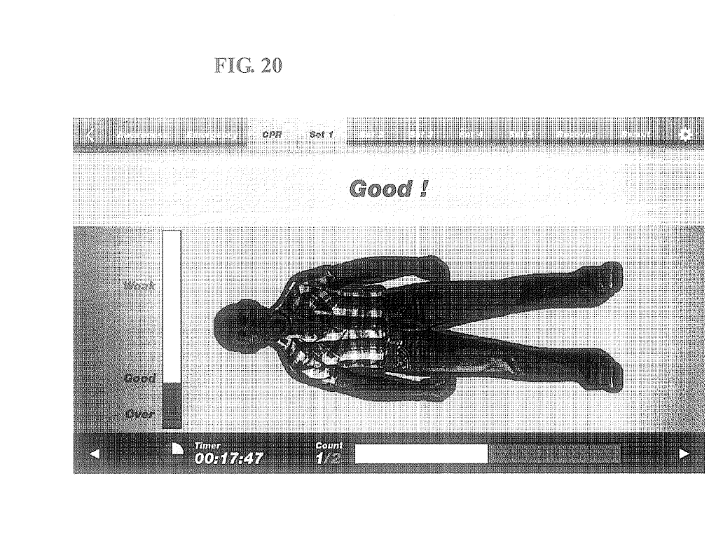

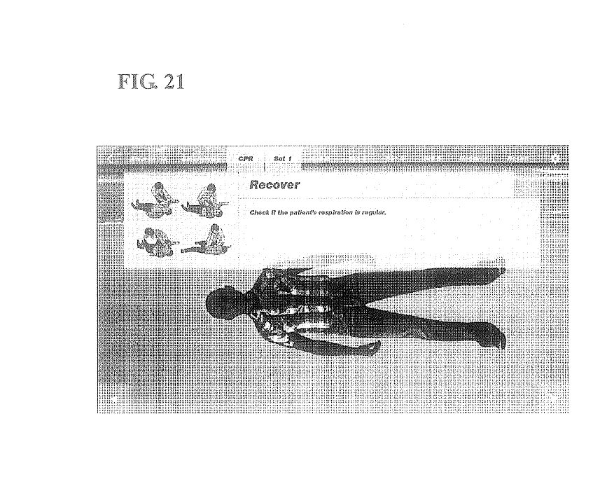

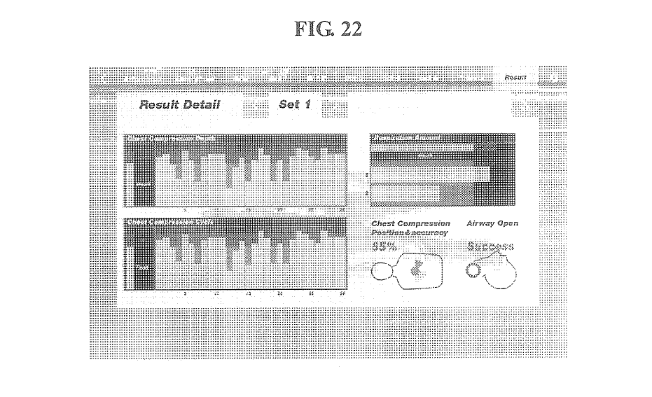

FIG. 15 is a diagram illustrating a virtual emergency situation scenario according to an example embodiment of the present invention. FIG. 16 is a diagram illustrating an emergency situation scenario selected in an example of FIG. 15. FIG. 17 is a diagram illustrating a procedure of checking a consciousness of a patient. FIG. 18 is a diagram illustrating a terminal screen displaying a procedure of making an emergency request or an aid request. FIG. 19 is a diagram illustrating a terminal screen displaying a chest compression process. FIG. 20 is a diagram illustrating a terminal screen displaying an artificial respiration process. FIG. 21 is a diagram illustrating a terminal screen displaying a procedure of post-processing performed after a recovery. FIG. 22 is a diagram illustrating a terminal screen displaying a process of evaluating first aid performed.

In the CPR training procedure, one set of chest compressions and one set of artificial respiration may be included in one set of a CPR operation, and the CPR operation may be performed a predetermined number of times in a program. The chest compressions may need to be correctly performed within “a predetermined period of time” on “a predetermined range” of a chest part by “an appropriate depth” “the predetermined number of times” as a basic condition. Also, reference data for verification may be changed by performing an update or calibration on the CPR training program or changed through a trainee setting mode in the CPR training program. For example, the predetermined set, the predetermined period, and the predetermined number of times may be changed through a program update, and the predetermined range, and the appropriate depth may be changed through a calibration in a program.

In advance of starting the CPR training, in operation S1410, a user may set a communication with the sensor kit 910 by positioning a human body model at an appropriate area and manipulating the portable terminal 1000 to start the CPR training.

In response to a manipulation of the user, the portable terminal 1000 may execute a CPR training program, and display virtual scenarios, for example, a coastal accident occurring in a beach, a cardiac arrest during an exercise, and the cardiac arrest due to a car accident, provided in a system such that the user select an emergency situation scenario, for example, the aforementioned three scenarios. FIG. 15 illustrates a screen displaying the virtual scenarios. When the user selects a virtual scenario, for example, the cardiac arrest due to the coastal accident, from the virtual scenarios, the portable terminal 1000 may display the selected virtual scenario as shown in FIG. 16 and then, start an education with an explanation about the virtual scenario. In this example, the portable terminal 1000 may provide the explanation about an emergency situation the user is facing and provide a realistic visual image and sound effect such that the user concentrates on the emergency situation. The aforementioned example may be performed in operation S1420 of FIG. 14.

When the CPR training is performed based on the emergency situation of the selected virtual scenario, the portable terminal 1000 may instruct the user to check a consciousness of a patient as illustrated in FIG. 17. The portable terminal 1000 may provide a method of checking the consciousness through voice guidance. Based on the voice guidance, the user may check the consciousness of the patient to verify whether the patient goes into cardiac arrest. When the consciousness check is completed, the portable terminal 1000 may prepare a subsequent operation in response to a user input performed by touching a “Next” button.

The portable terminal 1000 may output a display for making an emergency request or an aid request to surrounding people, and provide a tutorial about a procedure of making the emergency request or making the aid request to surrounding people first through the voice guidance. Through the voice guidance, the portable terminal 1000 may instruct the user to request one of the surrounding people to call 911. FIG. 18 illustrates an example of a screen displaying a procedure of making the emergency request or the aid request to the surrounding people.

The aforementioned process of checking the consciousness and process of making the emergency request or the aid request to the surrounding people may be performed in operation S1430 of FIG. 14.

In operation S1440 of FIG. 14, the chest compression may be actually performed to output a result of the chest compression. In this example, the portable terminal 1000 may instruct the user to compress the chest part based on a beat.

When the user performs the chest compression, the display 1030 may display a compression intensity of the user as illustrated in FIG. 11. Also, the voice guidance may be provided in a background to inform of the compression rate, and a remaining time may be indicated by a timer. Red auras surrounding the patient may be gradually changed to a green color when the CPR and the artificial respiration are appropriately performed. An image feedback and a voice feedback indicating whether a chest compression depth and a chest compression position are correct may be provided simultaneously. The image feedback may be provided by displaying the chest compression depth and the chest compression position of the user on a screen in real time. The voice feedback may be provided by providing a positive voice feedback in a case in which a corresponding set is performed successfully while a negative voice feedback is provided when the corresponding set is performed unsuccessfully.

Also, a method of indicating an appropriate intensity of chest compression using a green color, indicating an insufficient intensity of chest compression using a white color, and indicating an excessive intensity of chest information using a red color may be applied in an example.

Basically, the chest compression may need to be performed correctly within a predetermined period of time on a predetermined range of the chest part by an appropriate depth the predetermined number of times. Also, whether a first set of the chest compressions is successful may be determined based on whether the chest compression is performed on a correct position and whether a compression depth is within an appropriate reference range. When the chest compression is performed at an incorrect position and the compression depth is within the appropriate reference range, a corresponding set is determined to be performed incorrectly. Also, the number of times that the chest compressions are successful may be verified during a predetermined period of time, and a period, for example, duration for each process of the chest compression may be verified. Irrespective of whether the chest compressions are successful or a failure, all of the chest compression positions and the chest pressure depths of the user may be stored.

Subsequently, the artificial respiration may be performed in operation S1450 of FIG. 14. Basically, the artificial respiration may need to be performed by “normally establishing a free airway” and supplying an amount of air in “a reference range” “the predetermined number of times” within “a predetermined period of time”. A remaining time may be indicated on a timer and voice guidance may be provided in a background so as to inform of an artificial respiration rate. When the aforementioned artificial respiration success condition for each set is satisfied, the number on the counter may increase. An image feedback and a voice feedback indicating whether the free airway is established may be provided simultaneously. The image feedback may be provided by displaying a breathing amount during artificial respiration and whether the free airway is established by the user on the screen in real time. The voice feedback may be provided by providing a positive voice feedback in a case in which a corresponding set is performed successfully while a negative voice feedback is provided when the corresponding set is unsuccessful.

In detail, the portable terminal 1000 may display a feedback on the chest compression process of FIG. 19 on the terminal screen, and instruct that the artificial respiration be performed based on a beat. As illustrated in FIG. 20, a breathing pressure intensity of the artificial respiration process may be displayed on a screen 1030 simultaneously with the chest compression process. When the user arches a neck of the human body model to ensure the free airway, an indication that the free airway is established may be displayed on the screen 1030 with reference to FIG. 20. In an example, the portable terminal 1000 may indicate an appropriate breathing intensity using a green color, indicate an insufficient breathing intensity using a white color, and indicate an excessive breathing intensity using a red color. As an example, five sets may be designated to be performed twice in the artificial respiration. In this example, a currently executed set among the five sets may be displayed on a right upper end of the screen. Indicators of the terminal screen 1030 may not viewed by the user during a process of performing the artificial respiration. Thus, as illustrated in FIG. 20, a design may include an indication of the breathing intensity provided around the head and a white band indicating an intensity by which the pressure is to be applied such that a required intensity is recognized intuitively.

Whether a first set of artificial respiration is successful may be determined based on whether the free airway is ensured and whether a breathing amount is within an appropriate reference range. When the airway is obstructed and the breathing amount is within the appropriate reference range, the artificial respiration is determined to be performed incorrectly. In terms of the artificial respiration, the number of times that the artificial respiration succeeds may be verified during a predetermined period of time, and a period for each process of the artificial respiration may be verified. Irrespective of whether the artificial respiration succeeds or fails, all of the breathing amounts and whether the free airway is established by the user may be stored.

When this chest compression process and the artificial respiration process are terminated, the portable terminal 1000 may output the voice guidance about the consciousness check of the patient and the post-processing to be performed after a termination of the CPR in operation S1460 of FIG. 14 with reference to FIG. 19.

In operation S1470 of FIG. 14, the portable terminal 1000 may perform an analysis and an evaluation to provide assessment information on the first aid. The portable terminal 1000 may represent a total score and then, represent an achievement of the user for each set of each operation. FIG. 22 illustrates an example of the terminal screen displaying an operation of evaluating the first aid. Referring to FIG. 22, the portable terminal 1000 may represent information associated with, for example, the number of times that the user performs the chest compression and the artificial respiration for each set, the chest pressure depth, the chest compression period, the chest compression position for each process, the breathing amount, whether the free airway is established, the breathing period, whether the artificial respiration succeeds is determined for each process based on a predetermined reference, and the number of times that the artificial respiration succeeds for each set. Also, the portable terminal 1000 may determine that the user passes the process when the reference number of successes is satisfied, and determine that the user fails when the reference number of successes is not satisfied. The reference number of successes may be designated and changed as necessary, for example, in a program.

A portable terminal may provide raw sensor data or analysis data to the user, for example, a trainee, or a third party as a form of a comma-separated values (CSV) file or a text (TXT) file that may be read using an information management program such as an excel and the like.

The portable terminal may transmit information on the CPR training simulation performed by the trainee through the communication network 1300 to the server 1200, and store the information in the server 1200 in operation S1480 of FIG. 14.

When the user or a supervisor access the server 1200 using a terminal device after operation S1480 is performed, the server 1200 may verify the CPR training information including the CPR training procedure and a result of the user through the terminal device. The CPR training information transmitted to the server 1200 may include information associated with, for example, the number of times that the user performs the chest compression and the artificial respiration for each set of performing the CPR, the chest pressure depth, the chest compression period or duration, the chest compression position for each process, whether the chest compression succeeds determined for each process based on a predetermined chest compression reference, the number of success times for each chest compression set, the breathing amount, whether the free airway is established, the breathing period or duration, whether the artificial respiration succeeds determined for each process based on a predetermined reference, the number of success times for each artificial respiration set, and whether the user passes or fails the CPR training.

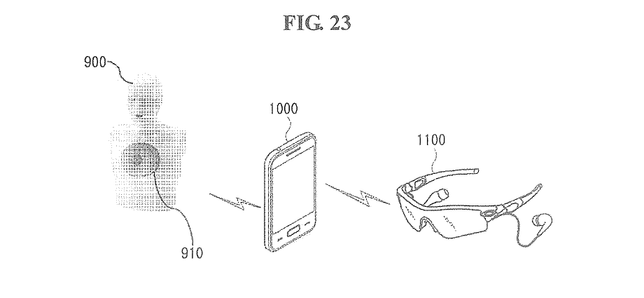

FIG. 23 is a configuration diagram illustrating still another example of a CPR training simulation system according to an example embodiment of the present invention.

Referring to FIG. 23, the CPR training simulation system may include the sensor kit 910, the portable terminal 1000, and a glasses-type display 1100. Here, the portable terminal 1000 may be connected to the sensor kit 910 and connected to the glasses-type display 1100 through a wireless communication. The CPR training simulation system may also include the server 1200 of FIG. 10.

The sensor kit 910 may sense first aid administered by a user to the human body model 900, and detect or measure information on the sensed first aid. Hereinafter, the information on first aid performed may also be referred to as, for example, first aid information. The first aid information may include, for example, chest compression information, artificial respiration information, and whether the free airway is established. In this example, the chest compression information may include, for example, a compression depth, a compression position, a compression intensity, the number of compressions, and a compression time, the artificial respiration information may include, for example, a breathing intensity, the number of breaths, and a breathing time, and whether the free airway is established may indicate, for example whether the airway is free or obstructed.

The portable terminal 1000 may execute a CPR training program installed in advance, and output CPR procedure guide information provided in the CPR training program through a reproduction. Also, the portable terminal 1000 may receive first aid information for each operation based on CPR procedure guide information from the sensor kit 910 in real time. The portable terminal 1000 may sequentially store the received first aid information in the memory 1020.

The portable terminal 1000 may transmit the CPR procedure guide information and the received first aid information to the glasses-type display 1100 in real time. When the CPR is terminated, the portable terminal 1000 may analyze the first aid of the user based on the first aid information stored in the memory 1020 and output a result of the analyzing.

The glasses-type display 1100 may receive data in real time through a wireless communication with the portable terminal 1000 and display the received data through a reproduction.

The glasses-type display 1100 may be, for example, an HMD wearable on an eye.

The glasses-type display 1100 may include an audio output module to output an audio signal. Thus, the glasses-type display 1100 may output the CPR procedure guide information, the received first aid information, and a result of analyzing the first aid information as a form of the audio signal.

Although the disclosure describes the CPR training system including the sensor kit 910, the portable terminal 1000, and the glasses-type display 1100 as an example, the disclosure may be implemented by combining the sensor kit 910 with the portable terminal 1000 or combining the portable terminal 1000 with the glasses-type display 1100.

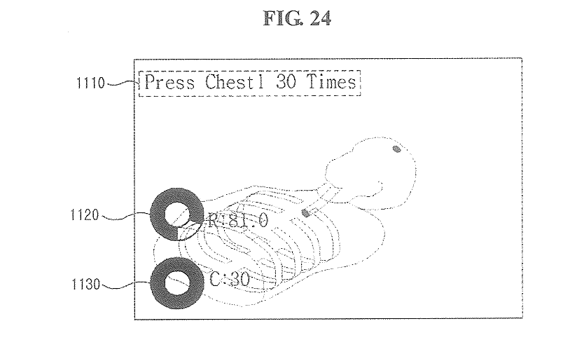

FIG. 24 is a diagram illustrating a screen displaying a CPR training feedback according to an example embodiment of the present invention. The following example embodiments may be provided to describe an image viewed by a user wearing the glasses-type display 1100.

The portable terminal 1000 may be connected to the glasses-type display 1100 through a communication, and execute a CPR training program based on a user command. When the user selects a training mode, the portable terminal 1000 may transmit the CPR guide information to the glasses-type display 1100. The glasses-type display 1100 may reproduce CPR guide information 1110 transmitted from the portable terminal 1000 and display the CPR guide information 1110 on one side of a screen.

When the user performs the CPR based on the CPR guide information displayed on the screen, the sensor kit 910 may measure first aid information of the user and transmit the first aid information through the portable terminal 1000 to the glasses-type display 1100. The glasses-type display 1100 may receive the first aid information and display the first aid information on the screen. The glasses-type display 1100 display a chest pressure rate 1120 and the number of chest compression times 1130 included in the first aid information on another side such that the CPR guide information 1110 does not overlap the first aid information.

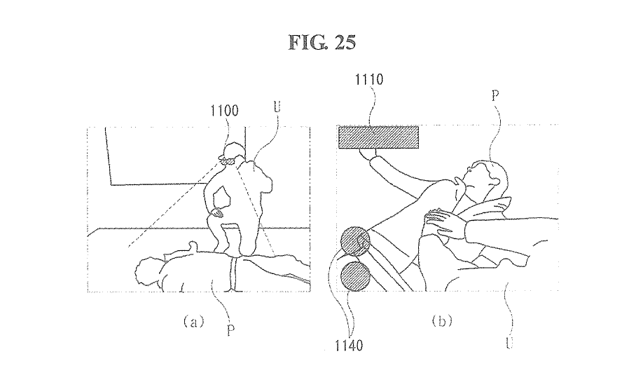

FIG. 25 illustrating a CPR execution procedure based on the CPR training simulation system of FIG. 23.

Referring to FIG. 25, when a user U recognizes a patient P, the user U may wear the glasses-type display 1100 and execute a CPR training program pre-installed in the portable terminal 1000. The portable terminal 1000 may execute the CPR training program in an actual mode in response to a user command.

The portable terminal 1000 may transmit CPR guide information including, for example, CPR procedures and methodology, to the glasses-type display 1100. The glasses-type display 1100 may receive the CPR guide information 1110 and display the received CPR guide information 1110 on a screen. Accordingly, the user U may perform CPR based on the CPR guide information displayed on the glasses-type display 1100.

Also, the glasses-type display 1100 may display a user interface 1140. The glasses-type display 1100 may sense a manipulation of the user interface 1140 and transmit information corresponding to the manipulation to the portable terminal 1000, thereby controlling an operation of the portable terminal 1000.

The simulation system and apparatus described with reference to FIGS. 1 through 25 according to the above-described embodiments may be recorded, stored, or fixed in one or more non-transitory computer-readable media including program instructions to be implemented by a computer to cause a processor to execute or perform the program instructions. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter.

The module described herein may be implemented using hardware components, a computer program, a piece of code, an instruction, or some combination thereof, to independently or collectively instruct and/or configure the processing device to operate as desired, thereby transforming the processing device into a special purpose processor.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An augmented reality (AR)-based interactive cardio pulmonary resuscitation (CPR) simulator comprising:
a compression information receiver to receive, from at least one pressure sensor, a compression intensity and a compression period input to the at least one pressure sensor;
an airway information receiver to receive, from an On/Off switch circuit, whether an airway of a dummy is expanded;
a flow rate information calculator to receive bending degree data of an air pocket received from a bending sensor, which is located in a lung part or an abdomen part of the dummy and tilted according to an expansion of the air pocket disposed in a lower portion so as to measure a status of an artificial respiration performed by a user through a mouth of the dummy, and calculate flow rate data for an amount of air flow in the airway based on a tilt of the bending sensor corresponding to bending degree data of the bending sensor; and
an AR outputter to output a result by comparing at least one item of received information to at least one item of reference information through a first projector.

2. The simulator of claim 1, further comprising:
a posture information receiver to receive, a red, green, and blue (RGB)-depth camera, an image capturing at least one RGB-depth sensor attached to a predetermined body part of the user to sense an angle for each body part while the user performs a CPR using the dummy,
wherein the AR outputter compares a position and an angle of the at least one RGB-depth sensor to a reference position and a reference angle, and outputs a result of the comparing.

3. The simulator of claim 2, wherein the predetermined body part is a waist, an elbow, and a wrist of the user.

4. The simulator of claim 1, wherein the at least one pressure sensor is mounted on at least one position on a chest part of the dummy, and at least one spring is disposed on a surface of an upper portion of the at least one pressure sensor.

5. The simulator of claim 1, wherein the at least one pressure sensor is mounted on at least one position on a chest part of the dummy, and the at least one pressure sensor mounted on at least one position contains location data to identify the at least one position.

6. The simulator of claim 1, wherein the AR outputter outputs a result by comparing a compression intensity input to the at least one pressure sensor to reference compression intensity information, calculates a pressure rate based on a compression period input to the at least one pressure sensor, outputs a result by comparing the pressure rate to reference pressure rate information, and outputs reference compression position based on the compression intensity input to the at least one pressure sensor.

7. The simulator of claim 1, wherein the calculated flow rate data is based on the tilt of the bending sensor corresponding to the bending degree data of the bending sensor, and the AR outputter outputs a result by comparing the flow data rate to reference flow rate data for a process of artificial respiration.

8. The simulator of claim 1, wherein the AP outputter outputs data indicating that the airway is expanded when the airway of the dummy is expanded and the On/Off switch circuit outputs an off state, and outputs data indicating that the airway is obstructed when the airway of the dummy is obstructed and the On/Off switch circuit outputs an on state.

9. The simulator of claim 1, wherein the AR outputter projects an AR-based emergency situation image representing an emergency situation through a second projector.

10. The simulator of claim 9, wherein an area toward which the second projector directs a projection is perpendicular to an area toward which the first projector directs a projection.

11. An augmented reality (AR)-based cardio pulmonary resuscitation (CPR) simulation system comprising:
a sensor kit universally attachable to and detachable from a human body model including at least one body part for use in an CPR training, and sense and collect at least one user input applied to the human body model for the CPR training when the sensor kit is mounted on the human body model; and
an AR outputter to output a result through a first projector by comparing information corresponding to the at least one user input collected by the sensor kit to at least one item of reference information.

12. The system of claim 11, wherein the sensor kit comprises:
a chest compression sensor located in a chest part of the human body model to measure at least one of a compression intensity, a number of compressions, and a compression times applied to the chest part; and
an artificial respiration sensor to measure at least one of a breathing amount, a breathing intensity, a number of breaths, and a breathing time applied to an oral cavity of the human body model through an artificial respiration.

13. The system of claim 12, wherein the sensor kit further comprises a compression position sensor to detect a position to which a pressure is applied in the chest part using pressure sensors or switch pads arranged on each of a plurality of different positions in the chest part when the sensor kit is mounted on the human body model.

14. A cardio pulmonary resuscitation (CPR) training apparatus comprising:
a chest compression sensor located in a chest part of a human body model including at least one body part for use in a CPR training to measure at least one of a compression intensity, a number of compressions, and a compression time applied to the chest part; and
an artificial respiration sensor to measure at least one of a breathing amount, a breathing intensity, a number of breaths, and a breathing time applied to an oral cavity of the human body model through an artificial respiration,
wherein the CPR training apparatus is universally attachable to and detachable from the human body model.

15. The apparatus of claim 14, further comprising:
a compression position sensor to detect a position to which a pressure is applied in the chest part using pressure sensors or switch pads arranged on each of a plurality of different positions in the chest part when the apparatus is mounted on the human body model.

16. The apparatus of claim 14, further comprising:
a free airway sensor to sense whether an airway of the human body model is free when the apparatus is mounted on the human body model.

17. The apparatus of claim 14, further comprising:
a communicator to wirelessly communicate with an external terminal; and
a controller to control the communicator to transmit at least one measured value of the chest compression sensor and the artificial respiration sensor to the external terminal.

18. (canceled)

19. (canceled)

20. The apparatus of claim 14, wherein the external terminal comprises at least one of a portable terminal and a glasses-type display.

21. The apparatus of claim 14, wherein the at least one measured value is compared to at least one item of reference information provided by the external terminal.

22. (canceled)

23. (canceled)

24. The system of claim 12, wherein the sensor kit further comprises a free airway sensor to sense whether an airway of the human body model is free.
